(19) United States
(12) Patent Application Publication
(10) Pub. No.: US 2019/0162014 A1
(43) Pub. Date: May 30, 2019

(54) SOLAR TRANSPARENT PV WINDOW AWNING POWER ACTUATED TO ADJUST TO SUN POSITION MAKING EXISTING WINDOWS MORE EFFICIENT PRODUCE ELECTRICITY AND REDUCE BUILDING AIR CONDITIONING USAGE

(71) Applicants: THOMAS EUGENE GLEASON, Las Vegas, NV (US); MARKO BRANKO OVCARIC, Belgrade (RS)

(72) Inventors: THOMAS EUGENE GLEASON, Las Vegas, NV (US); MARKO BRANKO OVCARIC, Belgrade (RS)

(73) Assignee: GLEASON PARTNERS LLC, Las Vegas, NV (US)

(21) Appl. No.: 16/143,780

(22) Filed: Sep. 27, 2018

Related U.S. Application Data
(63) Continuation of application No. 62/565,584, filed on Sep. 29, 2017.

(51) Int. Cl. E06B 5/10; H01M 10/46; H02S 40/38; H02S 20/32; E06B 7/28; E06B 5/12; E06B 9/24

(52) U.S. Cl. CPC E06B 5/10; H01M 10/465; H02S 40/38; E06B 2009/2476; E06B 7/28; E06B 5/12; E06B 9/24; H02S 20/32

(57) ABSTRACT

Solar Transparent PV Window Awning Power Actuated to Adjust to Sun Position, Making Existing Windows More Efficient, Produce Electricity, and Reduce A/C Usage is disclosed. G-P's linear actuators locks with solar window sash rigidly into place in any position from 9 to 120 degree angles. In case of fire for easy egress grenade type pins release easily from the linear actuators for unrestricted safe exit. With 12-V regulated power output solar PV powered awnings are safe, easy and fast to install on most windows in the world. Wide applications of this invention will reduce the need for building electricity, natural gas, help improve inside environment, security and comfort for occupants without the sun's glare or heat.

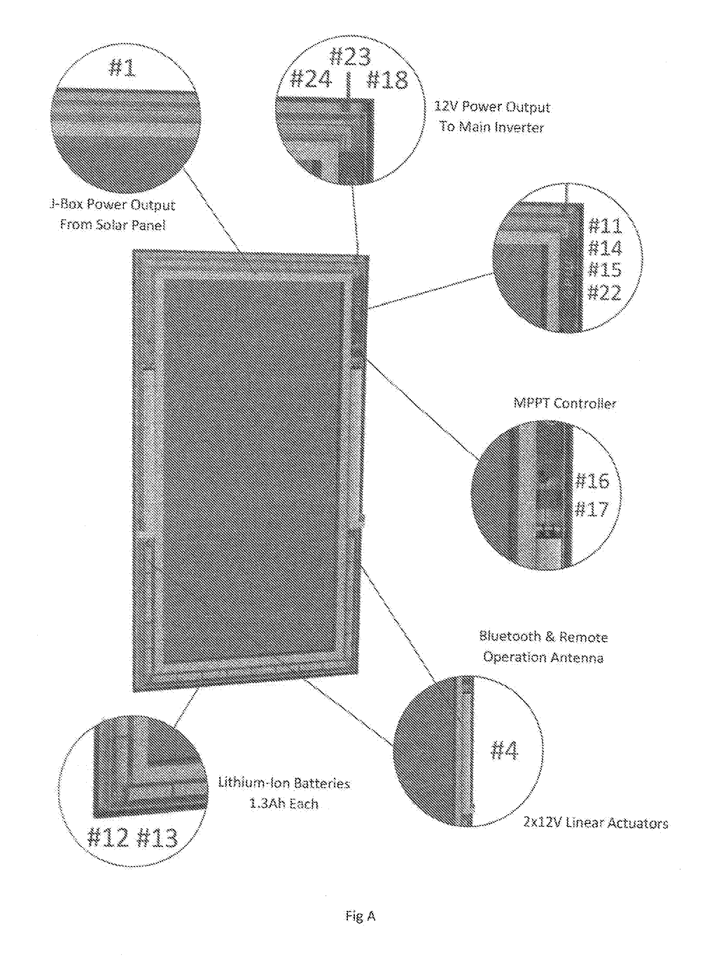

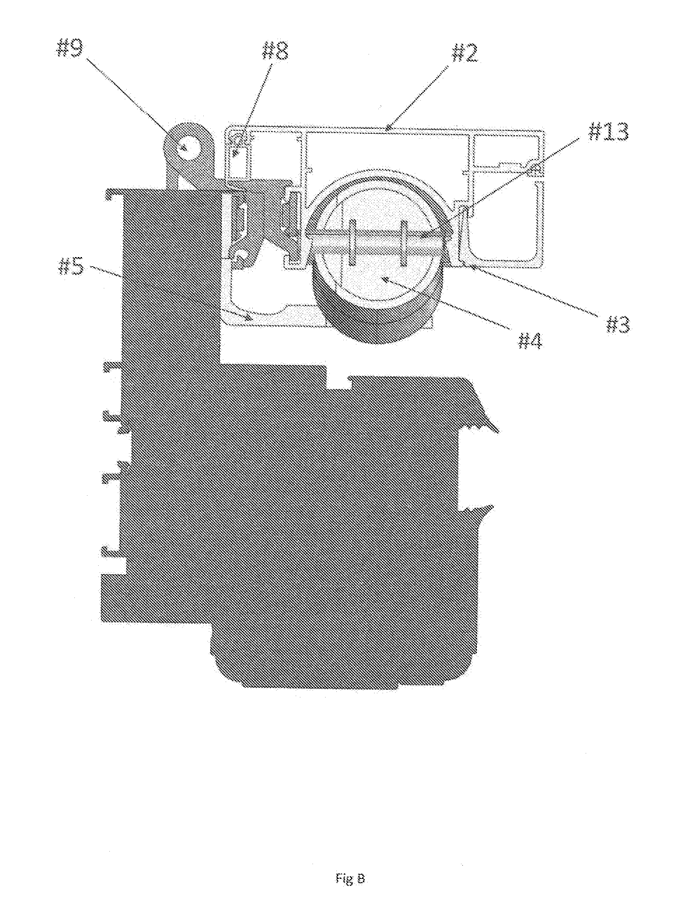

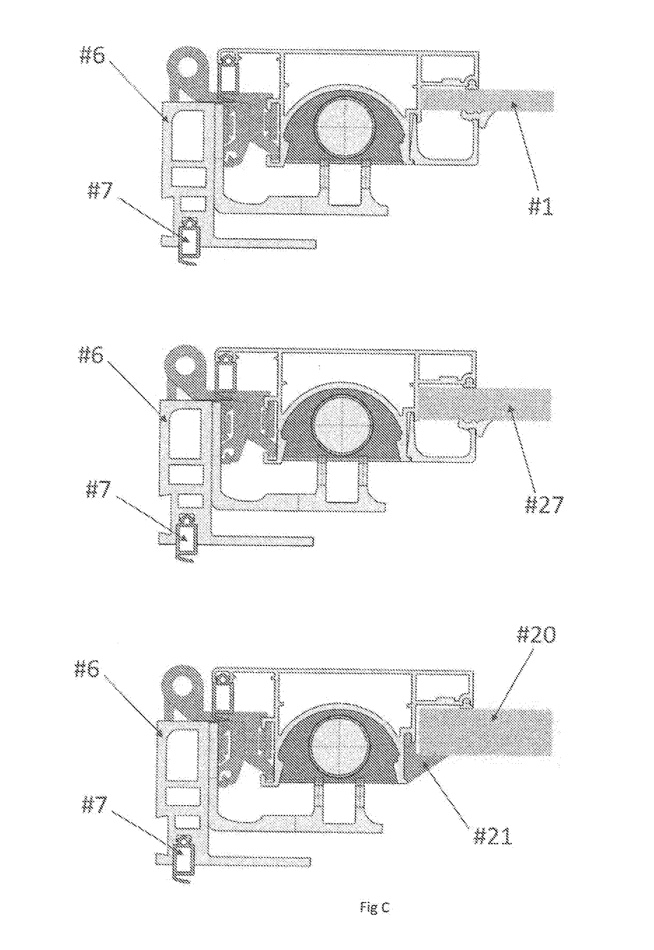

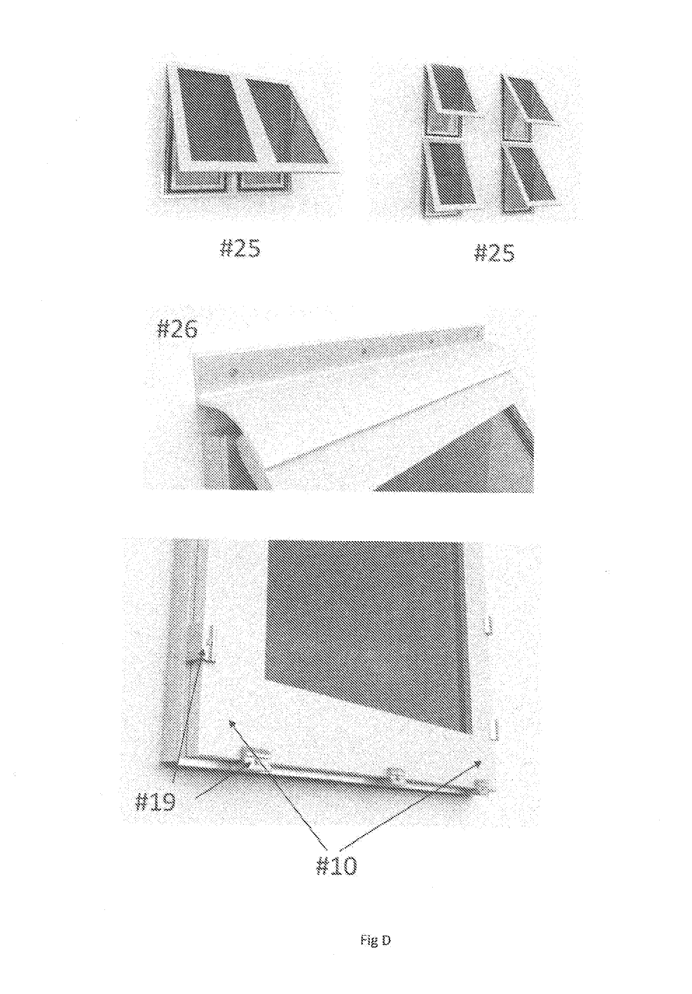

### BACKGROUND OF THE INVENTION

### Problem Solved

There are one Billion windows just in America that are inefficient and need replacement according to the DOE and AAMA. Gleason Partners LLC, G-P LLC's solar awning mounted on the outside wall over the window opening or directly mounted to the window frame creates improved efficiency and in many cases high performance for both old window system and newer window systems when closed plus generating electricity open or closed and provides shade control during the summer and allowing natural sunlight for heating during the winter.

Transparent solar modules were recently introduced in solariums, atriums, and curtain walls in some countries, but all are fixed. No solar windows on the market have adjustment that allow the occupant to adjust remotely to follow the sun for best electrical output or shading or to insulate the underlying window for best possible performance plus offers protect of the building from hurricane force winds and makes burglar access very difficult. Other power actuator systems used on industrial applications for windows and skylights/atriums are unacceptable in appearance and difficult to egress in case of emergency in office and residential applications.

G-P's (2) linear actuators locks down the awning to the window frame or outer wall rigidly in both closed and open positions of 0 to 120 degree angles. In case of fire grenade type pins release the clevis(s) easily from the linear actuator(s) for quick and safe exit. Designed with 12-V regulate power output makes the solar PV awnings safe from shock, subject only to low voltage regulations, and very easy for a handy person to install.

### DETAILED DESCRIPTION OF THE INVENTION

As stated above, there are one Billion windows just in America that are inefficient and need replacement according to the DOE and AAMA, in order to meet current building codes. G-P's solar awning mounted on the outside wall or directly mounted to the window frame creates superior performance power producing windows at low cost. The invention claimed within solves poor performance window problems, suitable for hundreds of millions of existing windows.

G-P's solar awning attaches to existing window top jambs or over the window opening providing high security protection from intruders, hurricane and potentially fire protection with optional wall mounted sub-frame.

When the occupant understands the benefits of the solar awning during the winter for maximum sunlight during the day, closing at night when cold and during summer shading the inside from the sun—reducing the buildings air conditioning, A/C, usage by 20% or more according to the NSF, National Science Foundation, and G-P's testing different times of the year and in different regions of the USA confirms.

The claimed invention differs from what currently exists. G-P is the only company to introduce residential and commercial premium window system with solar PV option in the USA and the first know in the world to introduce solar transparent PV powered window awnings in the world. Solar awnings fit on G-P premium aluminum thermal break windows, but designed to fit on or over most window types in the world greatly improving the original windows performance, with beautiful appearance, concealed linear actuators, MPPT controller, lithium battery storage, step down transformers, Blue Tooth, Antenna for remote open/close, and USB outlet for mobile phone and low voltage lighting in an emergency, all within the awning's frame.

One system installed in skylights around the world uses a chain link opener actuator and another type uses linear actuators that extend outside the window opening 2-3 feet. The chain system allows the wind to cause vibration and noise as the window sash moves and has limited angle adjustment. The linear actuator systems have industrial appearance and would never be acceptable in homes or office buildings. G-P's inventors needed its window actuator system to work with high reliability in future homes, office buildings, and high rise towers that would be attractive, energy generating with low voltage power, fit over existing windows and window openings of all types, operate remotely for home owner with a push button remote or an office tower with the building management system opening, closing and adjusting for uniform angle for best sun angle and to be able to remotely close in case of fire, bad storm conditions, or intruder sensed outside. Only G-P's window awning powered actuator is capable with its battery storage to provide the reliability needed in emergency conditions that can be managed simply by an open/close button inside or managed remotely by the building owner via their smart mobile or their building's energy and security management systems.

### THE VERSION OF THE INVENTION DISCUSSED—VIEW FIGURE A, B, C, D

1. SOLAR TRANSPARENT MODULES (10%, 20%, 30%, 40%) CLEAR VIEW—THIN FILM 6.8 MM THICKNESS SAFETY GLASS
2. OUTER AWNING ALUMINUM ALLOW AIRCRAFT GRADE HEAT TREAT FRAME
3. AWNING FRAME INSIDE ALUMINUM ALLOW COVER (REMOVED TO VIEW FEATURES)
4. 12-V POWERED LINEAR ACTUATORS (2) SELF LOCKING IN CLOSD AND ALL OPEN POSITIONS FROM ZERO TO 120 DEGREES (120 DEGREES IDEAL FOR MOUNTING ON NORTH FACING SIDE OF RV AND TRAVEL TRAILERS+IDEAL FOR INSTALL ON WINDOWS NORTH SIDE OF MULTI-STORY BUILDINGS NEAR THE EQUATOR FOR EXCELLENT SUN COVERAGE)
5. LINEAR ACTUATOR CLEVIS MOUNTED TO WINDOW SIDE JAMB OR WALL SUB-FRAME WITH GRENADE TYPE RING PULL PINS TO RELEASE IN EMERGY EXIT
6. ALUMINUM ALLOW AIRCRAFT GRADE INNER FRAME
7. RUBBER GASKETS—SEAL AWNING FRAME TO INNER SUB-FRAME OR TO G-P OR CUSTOMERS EXISTING WINDOW FRAME
8. RUBBER GASKET TO SEAL INNER OPTIONAL FRAME TIGHTLY TO CUSTOMER EXISTING WINDOW FRAME OR DIRECT TO WALL AROUND WINDOWS—DIFFERENT GASKETS TO MATCH WALL TYPE
9. DOUBLE JOINTED HINGES (2) TO (4) FOR OPTIONAL SECURITY & HURRICANE PROTECTION
10. OPTIONAL—ELECTRIC MAGNET LOCKS (2) TO (6) LOCATIONS OPTIONAL FOR HIGH SECURITY APPLICATIONS, HURRICANE PROTECTION, OR QUICK LOCK DURING HIGH ALERT IF SPECIFIED AS HIGH LEVEL BLAST BARRIER ON MILITARY BASES. AMBASSADOR RESIDENCES.
11. HYBRID MPPT CONTROLLER CHARGER REGULATING OUTPUT—SOLAR MODULE AT 12-V
12. BATTERY STORAGE (4) TO (60) Ah, (1.3-V EACH) LITHIUM BATTERIES DEPENDING ON AWNING FRAME SIZE, AND APPLICATION.
13. RUBBER INSULATOR MOLDED TO HOUSE WIRED LITHIUM BATTERIES END TO END INSULATED FROM THE ELEMENTS
14. DC AMPS AND VOLTAGE DISPLAY—OPTIONAL
15. USB OUTPUT FOR CELL PHONES AND LOW VOLTAGE LIGHTS WHEN POWER OUT.
16. BLUE TOOTH TO MOBILE PHONE CONTROLS
17. ANTENNA IN SYNC WITH MASTER CONTROL, INDIVIDUAL WINDOW CONTROL AND OPTIONAL WEATHER STATION SIGNAL FOR SEVERE WEATHER AUTO-CLOSE
18. OPTIONAL—INVERTER FOR CONNECTION TO 110-V OUTLET OR TO CENTRAL INVERTER
19. OPTIONAL—HURRICANE CLAMPING KITS—RIVET TO OUTER FRAME THAT HAS BEEN LAG SCREW INTO WOOD/STEEL STUD OR CONCRETE WALLS OR REINFORCED WINDOW ROUGH FRAMING, INSTALL OPTIONAL RUBBER GASKET TO SEAL WINDOW OPENING FROM STANDING FLOOD WATERS
20. OPTIONAL—SOLAR MODULE SAFETY GLASS LAMINATED WITH 2.28 MM SGP DUPONT LAMINATE (3.20 MM TEMPERED GLASS+0.40 CELL+3.2 MM TEMPERED GLASS+2.28 MM SGP+6.0 MM=15.08 MM=0.594 INCHES) THICKER GLASS REQUIRED FOR LARGE WINDOW SIZES
21. OPIONAL—DUPONT SILICON GLAZING FOR HURRICANE SECURE SOLAR AWNINGS
22. OPTIONAL—WEATHER STATION—WIND—RAIN—SNOW SIGNAL AWNING CLOSING
23. OPTIONAL—12-V CENTRAL BATTERY STORAGE SYSTEM—IDEAL FOR RV TRAVEL HOMES AND TRAVEL TRAILERS
24. OPTIONAL—LARGER WINDOW SYSTEMS—INVERTER WITH REMOTE MONITORING
25. OPTIONAL—STRUCTURAL MULLINS—STORE FRONT & LARGE WINDOW SECURITY
26. OPTIONAL—DRIP SHIELD—MOUNTED ON AWNING WALL APPLICATIONS
27. OPTIONAL—TRIPLE PANE-DOUBLE SAFETY GLASS OR THERMAL FOR EXTREME COLD WEATHER APPLICATIONS (10.4 MM=0.41″ THICKNESS) THERMAL DOUBLE OPTIONAL WITH 6.8 MM SOLAR GLASS+8 MM ARGON+5.0 MM TEMPERED GLASS

### RELATIONSHIP/INTERFACE OF THE MAJOR COMPONENTS/FEATURES

Fig. A, Item #1, Solar PV Module, generates variable DC power depending on irradiance level of the sun, angle of the module (best if directly facing the sun as it changes each week/month, changing very little each day but needs angle adjusted every few weeks by the owner remotely, with Item #11, MPPT control charger that converts the PV power generated by Item #1 with step down regulator to 12-VDC keeping Item #12, Lithium Batteries at full charge to 12-VDC, powering Item #4, Linear Actuators when activated by activating open/close buttons on remote, Item #17 (individual or master for up to 60 window awnings) or Item #16, Blue Tooth with smart phones to best angle for the sun or close during severe weather, which can be activated by Item #22, weather station. Surplus generated PV power is collected at a central battery bank for the facility, Item #23, or processed at a central inverter, Item #18, converting power from 12-VDC to either 110-VAC or 220-VAC wired to the main electrical panel. Item #11 MPPT Controller powers and regulates item #1, #12, #14, #15, #16, #17 with rapid shutdown in event of default(s) or Item #22 if weather station activates.

Fig. B, Item #2, Outer Aluminum Alloy Aircraft Grade Frame supports the heavy solar glass and houses in weather resistant insulated conditions Fig. A, Items #11-#21. Framing designed to withstand hurricane force winds with optional hurricane features:

Fig. C, Item #20 solar safety glass that will prevent 2″×4″×60″ wood stud projectile shot at 70 MPH with heavy glazing in Item #21, with hurricane clamping

Fig. D, Item #19 or use of electro-magnet locking with Item #10. With heavy gasket, Fig. B, Item #8, with solar awning mounted on wall over window opening with 4″ lag screws into jamb, sill, and side jamb frames will stop and provide level of water tightness to contain standing water, with Mullin cross bars reinforced for hurricane options, Item #25, designed for large, tall, or wide window openings, including store front windows, ideally with a stack of solar awnings, each with large and narrow height for best appearance and functional design to avoid interference or harm to people outside the windows on sidewalks.

### HOW THE INVENTION WORKS

By harnessing the sun's power to naturally heat the building during the winter to maximize the sun's radiant heating, while generating electricity and selectively block the sun's rays during the summer to minimize the use of air conditioning, and all the while maximize the comfort for the occupants, who are not required to close the blinds during the day to reduce glare or deal with the sun's heat. Solar transparent glass has the same comfort level as rooms without windows. With powered solar awnings to adjust to best angle of the sun, with an awning frame containing both the power from the solar modules and all the electronics to regulate and battery storage to power the linear actuators remotely or by most smart phones, equipping the home owners and building energy managers with the ability to maximize the power output from the solar awning, minimize the glare (eliminating the need for curtains/blinds during the day, discomfort caused by poor A/C performance.

Extensive testing using two identical offices with same size windows, facing directly south in Las Vegas, Nev., placing in Office #1-6′ wide×4′ high window opening (3) 2′ wide×4′ high 20% transparent solar modules in the window sill identical to recommended solar for window awnings. In Office #2-6′ wide×4′ high clean window opening. Place identical Red Velvet chairs in front of each office window and measure with temperature gun several times a month for one year. Findings: Office #1 temperature on red velvet chair identical to temperate of room, which temperature on red velvet chair of Office #2, recording 30 degrees higher in April than the chair in Office #1 when the sun is closest to the earth. In summer months, when the sun is furthest from the earth the temperature of the red chair in Office #2 was between 20-22 degrees higher than ambient temperature in Office #1 red chair. Every color except deep white with white backing produces same result. With 40% transparency instead of 20% difference between chairs in Office #2 is reduced in difference by 6 degrees, so 20% transparency is ideal for best occupant comfort.

G-P Powered Solar performance with transparent glass creates the opportunity world-wide to take Energy Management of residential and commercial building to one day reach Zero External Energy of demand from external sources with adequate battery storage and alternative power source such as the grid for bad weather days. Inventor met in Arlington, Va., USA with a senior Director of the National Science Foundation, NSF, who is committed to solar development that will develop and improve the efficiency of transparent solar glass that is economical for windows in the future. The NSF has published several times that solar PV transparent windows will cut air conditioning demand for most buildings a minimum of 20% and that G-P's other inventions with solar PV curtain walls, Solar window walls, and rain walls have potential with solar windows to reduce building demand for external power by 60-70% on new or buildings equipped with new solar envelopes.

G-P's powered solar window actuators works with all types of bug screens, nearly every type of window or window opening, and is a product expected to have world-wide acceptance with low cost of installation, low voltage power output, which is not regulated in USA or most counties building codes, and at 12-VDC is uniform voltage for passenger vehicles world-wide.

### HOW TO MAKE THE INVENTION

G-P has developed this solar window awning product line to use the same manufacturing equipment now used to manufacture premium aluminum thermal break commercial windows. Production capacity of solar transparent glass in many sizes and various colors, with most efficient CdTe and CIGS thin film will grow in capacity ten-fold during 2019 and is nearly equal in cost in USA to conventional window insulated glass and not subject to Trade Import Fees. Most buyers will love having high security window options in children's bedrooms, business, being able to avoid replacement of existing windows, cutting the owners power usage, eliminated in the sun's heat, no need for closed curtains/blinds during the day, ability to view outside during the day without outsiders viewing inside, stop fading of painted walls, carpets, furniture, quick recovery of costs with energy saving and satisfaction that they are not contributing to “Global Warming”.

G-P LLC has developed several building envelop solar PV power generating products, such as solar window walls for skyscrapers, solar curtain walls and solar rain curtain walls for government and commercial buildings, solar balcony systems, solar premium windows and sliding doors for condo and high end apartment buildings. Designed for new construction and rehab of high rise buildings built in the 1960's through 1990's that require major renovation because of water intrusion, poor performance of glass and walls, older chiller A/C systems that can be downsized with G-P energy products. The building market world-wide needs G-P's type of building envelopes, so that architects begin designing buildings with maximum energy efficiency to help reverse Global Warming and the world's dependency on non-renewable resources and stop designing buildings that we must live with for 100 years that are sub-standard with today's low overall cost ready for mass production technology.

Our solar window powered awning has been designed for 25-30 years of trouble free electric production and a life time of air conditioning reduction and high level of security from intruders and protection from hurricane force winds and large flying objects. Years after the solar electricity generation begins to fail in 30-35 years or perhaps long and exterior powder coated finish guaranteed for 20 years, G-P window awning owners will retain a high level of performance and delay weather related failure of their windows for perhaps many more decades.

Within 5-10 years, inventors would like to see solar transparent windows being manufactured and used as standard equipment on every type of home, office, and high rise buildings in every country. Inventors hope to help people around the world to benefit by low energy costs and weather protected expensive conventional windows and hopefully governments will one day begin to regulate “Best Practices” with regard to building construction that should include solar window powered awnings.

What do we claim:

1. Window Awning System Remote Actuated Invention Comprising:
a. Solar Transparent PV Glass that generates electricity to provide power that is stored in the integral batteries to actuate the linear
b. actuators on command remotely, send power generated to central battery storage or building inventers
c. MPPT Controller with step down transformed, converting PV glass power to regulated 12-VDC. Controller equipped with many features to charge the batteries, communicate remotely via Blue Tooth or antenna and signal default of system fails. The low voltage 12-VDC system is acceptable world-wide without regulations, easy and safe to install, and the low voltage is used world-wide for controls and vehicles, and a perfect option for recreational travel homes and trailers with built in low voltage power systems.
d. Aircraft grade aluminum extruded, inner and outer frame protects MPPT controller, step down transformer, lithium batteries, lithium batteries, communication links, USB port(s) from the heat and weather, all contained with the frame designed to house are pieces of heavy solar or conventional glass.
e. Windows designed to open from zero degrees to 120 degrees which is ideal during window cleaning from the outside, installation in apartment buildings, even on the north side near the Equator and when installed on north side recreational vehicles near the roof can be indexed to 90 degrees for solar collection.

2. Solar Window Awning with Power Actuator permits remote adjust:
a. Maintain best angle of the sun either by occupant inside the building near the window(s), via occupant/owners smart phone, security system, or managed by the buildings energy management system.
b. Wireless remote actuated solar window awning provides for automatic or manual closing in event of fire, hail storm, rain, snow, high winds, and security—protecting and sealing the original window if left open from the elements with the optional weather station or local news station alert.
c. In event of emergency the heavy duty frame with powered actuators, will handle the stress and load of the solar window awning if equipped with heavy glass that can protect the building from hurricane force winds, flying objects, standing flood waters, high level blast and high level protection from intruders.

3. 20%, 30%, or 40% Transparent Window Awning with Power Adjustment allows the owner to remotely adjust the angle to the sun for highest output of PV electricity and manage sun entering the building
a. Provides screening of the harmful and often hot sun's rays from entering the room nearly eliminating glare without the need for shades or curtains, and nearly eliminating fading of wood furniture, carpet, wall paint
b. Prevents outsiders from viewing into the window during the day
c. Functions as an awning should when drawn back or raised above 100 degrees by allowing sun into the building for heating the room
d. Permits inside windows to be open and not worry about rain
e. Expectation that air conditioning loads in the building with solar glass will be 20% lower or more and occupants will not experience the hot/cold spots at different times of the day. Actually, the need for air conditioning will become optional for many occupants more days of the year

4. Solar Transparent Window Awning in both open and closed position will extend the useful life of existing windows.
a. Vinyl, wood, aluminum clad, and even premium aluminum windows will be protected from the harsh sun's rays especially on the south and west sides of buildings, nearly eliminating warping, color fading, water intrusion with caulking failure, plus protect the window mechanisms.
b. Performance of conventional existing windows will have a major impact on energy savings during the summer and winter when the solar awning is closed and seals the existing window from the harsh elements.
c. Properly maintained existing windows protected by the G-P Solar Window Awning have the potential of lasting decades longer.
d. Ease of installation of the G-P awning by the building owner or handy man, reasonable cost, and the fact the solar glass generates electricity and cuts air conditioning makes this invention a must have for new construction and building upgrades for energy and appearance.
